(19) United States
(12) Patent Application Publication
(10) Pub. No.: US 2012/0208726 A1
(43) Pub. Date: Aug. 16, 2012

(54) COMPOSITION AND METHOD FOR REMOVING FILTER CAKE

(76) Inventors: KERN SMITH, The Woodlands, TX (US); Xiaolan Wang, Spring, TX (US)

(21) Appl. No.: 13/028,963

(22) Filed: Feb. 16, 2011

(51) Int. Cl. C09K 8/00

(52) U.S. Cl. 507/201; 507/203; 507/259

(57) ABSTRACT

An embodiment of the present disclosure is directed to a well servicing fluid emulsion. The well servicing fluid is formulated with components comprising an ester of an organic acid for which the pKₐ of the organic acid is less than 0; an aqueous based fluid and an emulsifier. The ester is dispersed in the aqueous based fluid to form the well servicing fluid emulsion.

### FIELD OF THE DISCLOSURE

The present disclosure relates generally to fluids used in hydrocarbon producing welts for reducing filter cake from well formations and to methods for removing the filter cake.

### BACKGROUND

Water based drilling fluids (DIF) are widely applied in horizontal and multilateral well drilling. DIFs are formulated to deposit a relatively impermeable filter cake that seals the wellbore and minimizes fluid loss into the formation. During completion operations, it is often desirable to remove the deposited filter cake to prevent reduced completion efficiency and production rates. This, however, can be a challenging task, especially in long horizontal, extended reach and/or multilateral wells with heterogeneous formation characteristics. In these cases, the inability to obtain complete filter cake removal is a common occurrence with the currently available reactive fluid systems.

The compositions of water based DIFs commonly include, for example, xanthan gum, starch, cellulose, calcium carbonate, salt and other additives. The formed filter cake from DIF is comprised of sized-carbonate and polymers. Over the years, different approaches to clean the filter cakes have been suggested and applied. Hydrochloric acid (HCl) is the most commonly used chemical to remove the acid-soluble filter cake. While HCl acids can dissolve carbonate and some polymers, its high reaction rate may cause undesired nonuniform filter cake removal (even the reaction rate with weak organic acids are too fast, which results in incomplete filter cake removal). Polymer breakers such as enzymes and oxidizers have been frequently used as well. Although polymer breakers can break down the polymers into smaller fragments, they are not able to dissolve carbonate particles. Chelating agents (such as EDTA) also have been used as an alternative to HCl to remove filter cake. But similar to HCl, their reaction rate with CaCO₃ is fast. Certain MUDZYME® formulations, available from BJ Services Company, U.S.A, combine a chelating agent with enzymes in order to serve the dual purpose of degrading polymers and dissolving CaCO₃. However, laboratory studies of this system showed that while MUDZYME formulations are effective, the breaking of the filter cake is achieved without much of the desired delay time.

Another instance where conventional filter cake removal systems are not adequate is when there is a desire to place, or “spot,” the treatment fluid at a selected position in the well, prior to running final completion. In some instances, this operation can take up to several days. A formulation has been reported that uses an organic acid precursor that generates acid in-situ. See, “Evaluation of In-Situ Generated Acids for Filter-Cake Cleanup,” Al Moajii, et al., SPE 107537 (2007). But testing has demonstrated dissatisfactory cleaning results of filter cake due to the weak acidity of the acid generated from the acid precursor.

White advances have been made in filter cake removal, further improvements would be a welcome addition in the field. In particular, there is a need for improved methods of removing the drilling fluid filter cake in order to clean and effectively stimulate horizontal, extended-reach and multilateral wells.

### SUMMARY

The well servicing fluids of the present disclosure can provide one or more of the following advantages, including: improved filter cake dissolution, adequate delay of acid production, improved distribution of the treating fluid across relatively long sections of a well, reduced leak-off during placement of the fluid in the well, the ability of the ester to hydrolyze over time to generate acid in situ, relatively low corrosivity of the fluid compared to some strong acid based fluid cake removal systems (such as HCl), or compatibility of the ester with enzymes to make dual-function systems effective for removing carbonate and polymers in a filter cake.

An embodiment of the present disclosure is directed to a well servicing fluid emulsion. The well servicing fluid is formulated with components comprising an ester of organic acid for which the pKₐ of the organic acid is less than 0; an aqueous based fluid and an emulsifier. The ester is dispersed in the aqueous based fluid to form the well servicing fluid emulsion.

Another embodiment of the present disclosure is directed to a method of removing filter cake from a well. The method comprises providing a well servicing fluid formulated with ingredients comprising an ester of organic acid for which the pKₐ of the organic acid is less than 0, an aqueous based solvent and an emulsifier. The well servicing fluid is introduced into the well so as to contact a well formation having filter cake deposited thereon. The well servicing fluid removes at least a portion of the filter cake from the well formation.

### DETAILED DESCRIPTION

An embodiment of the present disclosure is directed to a well servicing fluid. The wells servicing fluid is formulated with components comprising: an ester of organic acid for winch the acid dissociation constant, pKₐ, of the organic acid is less than 0; an aqueous based fluid and an emulsifier. The ester is dispersed in the aqueous based fluid to form an emulsion.

The formulation can optionally include other ingredients, such as, for example, one or more of the following: an enzyme, a pH buffer, and an emulsifier. These and other optional ingredients are discussed in greater detail below.

### Ester of Organic Acid

The ester of organic acid employed in the composition of the present application can be any suitable ester of a organic acid that will provide for suitable delayed release of an acid for which the pKₐ is less than 0, and that is capable of removing filter cake from a well formation. The delay can be accomplished by choosing an acid ester that undergoes hydrolysis at a relatively slow reaction rate at ambient well conditions. This allows acid to be produced slowly, which in turn allows the ester to be more uniformly distributed throughout the well before the acid is completely released, resulting in more uniform filter cake removal.

The rate of release of acid can be measured in terms of half life time of the reaction. The half life time is the time it takes to release 50% of the unreleased acid. The desired half life may vary depending on, among other things, the configuration of the well (e.g., horizontal, vertical, or multilateral wells), the well operation, the rate at which the produced acid removes the deposited filter cake and the residence time of the ester in the well. The actual half life for a given ester can also depend on the downhole temperature of the well in which it is employed. An example of a range for half life is from about 24 to about 36 hours at 180 degrees F.

Esters are generally oily organic chemicals that are not miscible with water. The organic acid ester can be chosen so that its organic acid has sufficient acid strength to generate effective stimulation upon hydrolysis. As discussed above, the pKₐ of the organic acid is less than zero. For example, the organic acid can be a strong acid, which is defined herein as having a pKₐ of less than about −1.74.

Examples of suitable esters of strong organic acids include esters of sulfonic acids of the general formulae 1:

R¹—S(═O)₂OR² (1)

where R¹ and R² are independently chosen from C₁ to C₁₂ aryl groups and C₁ to C₁₂ aliphatic groups.

Suitable organic acid esters include esters of organic sulfonic acids, such as methyl methanesulfonateand ethyl methanesulfonate. In an embodiment, the ester of strong organic acid is an ester of toluene sulfonic acid. Examples of suitable toluene sullonic acids include methyl p-toluenesulfonate and ethyl p-toluenesulfonate. A commercially available ester of toluene sulfonic acid is DA-1, from BJ Services Company, U.S.A., of Houston Tex.

In an embodiment, the organic ester may be introduced into the well as a component of an emulsion. The emulsion can be a microemulsion, such as a single phase microemulsion. In an embodiment, the organic ester may be introduced into the well as a component of an oil-in-water emulsion having an emulsifier as the oil phase. A stable oil-in-water emulsion can be formed by mixing the esters with water and a suitable surfactant. Typically, the emulsion contains from about 2 to about 10 volume percent of organic acid ester. Suitable emulsifiers are discussed below.

### Aqueous Based Fluid

Any suitable aqueous based fluid can be employed in the compositions of the present application. Examples of suitable aqueous based fluids include fresh water, brine, seawater and produced water.

The brine may be any brine that serves as a suitable media for the various components. As a matter of convenience, in some cases the brine base fluid may be a brine available at the well site, for example. The brines may be prepared using at least one salt, such as, but not limited to, NaCl, KCl, CaCl₂, MgCl₂, NH₄Cl, KBr, CaBr₂, NaBr, ZnBr₂, sodium formate, potassium formate, cesium formate, and mixtures thereof, and any other stimulation and completion brine salts.

The concentration of the salt in the brines can range from about 0.5% by weight, based on the total weight of the brine, up to saturation for a given salt. Example concentrations of salts include 1%, 3%, 10%, 20%, 30% or more salt by weight of brine. The brine may be a combination of one or more of the mentioned salts, such as, for example, a brine prepared using KCl and KBr, NaCl and CaCl₂, or CaCl₂ and CaBr₂.

### Enzymes

Enzymes can be included in the compositions of the present disclosure. In an embodiment, enzymes can aid in removing polysaccharides such as, for example, xanthan gum, guar, starch, or cellulose, as well as any other type of polymers that may be deposited on the well formation by drilling fluids. The enzymes employed may vary depending on such things as the type of polymers or other filter cake components to be removed, the effectiveness of a given enzyme at ambient well temperatures and the compatibility of the enzyme with other components in the emulsion.

Any suitable enzyme capable of aiding in the cleaning of one or more filter cake components can be employed in the compositions of the present disclosure. Examples of suitable enzymes include xanthanase, hemicellulase, Cellulase enzyme, bacterial amylase, and other glycosyl hydrolases.

Examples of a commercially available enzymes include GBW-14C and GBW-16C, both available from B.J. Services Company, U.S.A., of Houston, Tex. In an embodiment, two or more enzymes can be employed in the compositions of the present application.

### pH Buffers

Any suitable pH buffer that is capable of maintaining a desired pH can be employed in the compositions of the present disclosure. For example, some enzymes may more effectively function within certain pH ranges. In this case, pH buffers may be employed to maintain the pH within the effective operating range of the enzymes for a sufficient period of time to allow acceptable cleaning to occur.

Examples of well known pH buffers include NaOH, KOH, potassium bicarbonate, sodium bicarbonate, potassium carbonate, and sodium carbonate (Na₂CO₃). An example of a commercially available buffer is BF-7L, available from BJ Services Company, U.S.A., of Houston, Tex.

The desired pH of the fluid may depend on a number of factors, including the type of enzymes or other ingredients employed in the formulation and the application for which the formulation is intended. Thus, any desired pH range can be maintained, including acidic, neutral and basic pH ranges, using one or more suitable buffers. In an embodiment, the ranges from about 3 to about 10, such as from about 5 to about 7.

### Emulsifiers

Any suitable emulsifiers can be employed in the compositions of the present application, such as those suitable for forming oil-in-water emulsions, including microemulsions. Suitable emulsifiers are those which are capable of making an emulsion with the organic acid ester. Anionic and cationic emulsifiers may be used. In an embodiment, nonionic emulsifiers are employed.

Examples of suitable nonionic emulsifiers include long chain emulsifiers or emulsifiers based on fatty alcohols. For instance, suitable non-ionic ernul ers can include compounds comprising a polyether alcohol comprising a lipophilic moiety. The polyether alcohol group can be, for example, a polyethyloxide or polypropyloxide group, or a combination of ethyl oxide and propyl oxide units. The lipophilic moiety can be an aliphatic or aromatic, linear, branched or cyclic group having about 8 to about 30 carbon atoms.

In an embodiment, the polyether alcohol comprising a lipophilic moiety can have a Formula (2):

R₃(OR₄)ₙOH (2)

where

R₃ can be any lipophilic group, including an aliphatic or aromatic, linear, branched or cyclic group having about 8 to about 30 carbon atoms;

R₄ can be an ethyl or propyl group; and

n can range from about 3 to about 50 or more.

Examples of the aliphatic or aromatic R₃ groups include linear or branched alkyl groups or alkylar groups.

Examples of polyether alcohol comprising a lipophilic moiety include fatty alcohol ethoxylates, alkyl polyether alcohols and alkylaryl polyether alcohols. More than one emulsifier compound can also be employed, such as a combination of alkylaryl ethoxylates and polyethylene glycol (PEG) esters of fatty acids.

The fatty alcohol ethoxylates can be formed by ethoxylation of fatty alcohols, as is well known in the art. Examples include the reaction of 4 to 8 moles of ethylene oxide per mole of a 10 to 14 carbon alcohol. An example of a compound that may result from such a reaction is C₁₂ alkyl-(OC₂H₄)₆OH.

Examples of alkyl and alkylaryl polyether alcohols include (a) a linear or branched alkyl group or alkylaryl group having from about 8 to about 30, such as about 8 to about 20, carbon atoms, and (b) a linear or branched polyethylene oxide group having about 3 to about 50 ethyloxide units, such as about 3 to about 20 ethyloxide units. In an embodiment, the emulsifiers can be alkyl polyoxyethylene alcohols comprising, for example, a linear alkyl group having from about 13 to about 15 carbon atoms and a polyethylene oxide group having 10 ethylene oxide units with a terminal hydroxide functional group. Further suitable emulsifiers include nonylphenol ethoxylate having an HLB value of about 16 and comprising 20 ethylene oxide units per molecule, octylphenol ethoxylate having an HLB value greater than 13.5, and nonylphenol ethoxylate having an HLB value greater than 13.

As discussed above, a combination of alkylaryl ethoxylate and a polyethylene glycol (PEG) ester of a fatty acid can be employed. Examples include alkylaryl ethoxylates comprising octyl, nonyl or dodecylphenol groups and an ethoxylate group comprising about 3 to about 13 moles of ethylene oxide. The polyethylene glycol (“PEG”) ester can be formed, for example, by reacting PEG with unsaturated fatty acids in a mot ratio ranging from about 1:1 to about 1:2 to form a compound having a molecular weight ranging from about 200 g/mol to about 600 g/mol.

An example of a commercially available emulsifier is S-400, available from BJ Services Company, U.S.A., of Houston, Tex.

As discussed above, any of the above emulsifiers can be employed to form an emulsion comprising an ester of organic acid, as disclosed herein. One example of a stable oil-in-water emulsion ay be formed by mixing DA-1 with 1% nonylphenoxypoty(ethyleneoxy)ethanol surfactant. ps Other Ingredients

One or more additional compounds can be included in the well servicing fluids of the present disclosure. The well servicing fluid can comprise, for example, at least one additional compound chosen from oxidizers, chelating agents, surfactants, clay stabilization additives, scale dissolvers, high temperature stabilizers, corrosion inhibitors, corrosion intensifiers, mutual solvents, alcohols, and other common and/or optional components.

The compositions of the present disclosure can form stable oil-in-water emulsions. In an embodiment, the emulsions can be microemulsions. The emulsions can be formed by any suitable method of mixing the ester of strong organic acid in the aqueous based fluid. Suitable emulsion forming techniques are well known, including techniques involving high shear mixing and/or the use of emulsifiers. Forming emulsions, including microemulsions, is well within the ordinary skill of the art given the guidance provided in the present disclosure.

### Methods of Reducing Filter Cake

The present disclosure is also directed to a method of removing filter cake from a well using any of the well servicing fluids described herein. The method comprises providing a well servicing fluid formulated with ingredients comprising an ester of strong organic acid and an aqueous based solvent. The providing step can involve obtaining the well servicing fluid in a prepared condition, or can involve obtaining the component ingredients and preparing the well servicing fluid on site. In addition to the ester and aqueous based solvent, the well servicing fluid can further comprise any of the other ingredients discussed herein.

The well servicing fluid is introduced into the well so as to contact a well formation having filter cake deposited thereon. For example, the well servicing fluid can be introduced into the well by pumping the fluid through tubulars, such as an annulus, production tubing or other well conduit, so as to contact the well formation. The well can be any suitable type of well, such as horizontal wells, extended reach wells and multi-lateral wells. The well servicing fluid removes at least a portion of the filter cake from the well formation.

The method can further comprise removing the well servicing fluid from the formation after the fluid contacts the formation. This removing step can be performed by any suitable technique, including techniques known in the art, such as by pumping the fluid from the well. The removed well servicing fluid can be recovered, recycled or disposed of according to industry standard practices.

The removing step can be performed at any time after the well servicing fluid contacts the formation. For example, the contacting step can be performed for a sufficient time for removing an acceptable portion of the fluid cake, followed by the removing step. The length of time can range from about 24 hours to several days (e.g. 2 to 4 days).

In an embodiment, the method can further comprise depositing a filter cake prior to introducing the well servicing fluid into the well. For example, the filter cake can be deposited by contacting the formation with a drilling fluid during well drilling processes. The filter cake can comprise at least one component chosen from, for example, carbonates and polymers, such as xanthan gum, starch or cellulose.

The present disclosure will be firther described with respect to the following Examples, which are not meant to limit the invention, but rather to further illustrate the various embodiments.

### EXAMPLES

The following examples were carried out and demonstrate the effectiveness of the compositions of the present disclosure for delayed removal of filter cake. In Examples 1-3, the filter cake was prepared from a 8.9 ppg KCl based drill-in fluid (“DIF”) with ingredients including water, KCl, xanthan gum, starch, CaCO₃, and buffer. The prepared DIF was filtered through a 2 Darcy ceramic disc in an HTHP cell to generate the filter cake. In example 4, the filter cake was prepared from a 11.0 ppg NaBr based drill-in fluid (“DIF”) with ingredients including water, NaBr, xanthan gum, starch, CaCO₃, and buffer. The prepared INF was filtered through a 2 Darcy ceramic disc in an HTHP cell to generate the filter cake.

Examples 1 to 4 below employ a methyl ester of toluene sulfonic acid in various formulations to remove the prepared filter cakes.

### Example 1 Formulation

An emulsion of the present disclosure, which included 10% by volume DA-1 (methyl ester of toluene sulfonic acid), 0.5% by volume S-400 (an emulsifier), 5% by volume GBW-14C (enzyme), 1% by volume GBW-16C (enzyme) and 0.1% by volume BF-7L (buffer), was last added to the HTHP cell at the target temperature (180° F.) and 500 psi for designated time under static condition. Fresh water was used as the solvent. The method of forming the emulsion included adding 0.5 ml of S-400 to 83.4 ml of fresh water in a warring blender under strong agitation. After 15 seconds, 10 ml of DA-1 was added to the blender. Upon mixing for 45 seconds, BF-7L (0.1 ml), GBW-14C (5 ml), and GBW-16C (1 ml) were added and kept stirring for 10 seconds.

### Example 2 Formulation

Example 2 was similar to the composition of Example 1, except that Example 2 did not include a buffer. The Example 2 composition was added to an HTHP cell at the target temperature (180° F.) and 500 psi for designated time under static condition, similarly as discussed above in Example 1.

### Examples 3 and 4 Formulations

Example 3 and Example 4 were similar to the composition of Example 1, except that Example 3 and Example 4 did not include a buffer or enzymes. The Example 3 composition was added to an HTHP cell at the target temperature (180° F.) and 500 psi for designated time under static condition, similarly as discussed above in Example 1. The Example 4 composition was added to an HTHP cell at target temperatures of 150° F., 180° F., and 200° F. and 300 psi for 48 hours under static conditions.

The filter cakes were each checked after soaking for 24 hours, 48 hours and 72 hours in the Example formulations 1 to 3 above. The results of the testing will now be described.

For the formulation of Example 1, after soaking for 24 hours, the majority of the surface of the 2 Darcy ceramic disc was still covered by filter cake, although a substantial portion of the filter cake had been removed. At 48 hours, most of the filter cake had been removed, with only a relatively small portion remaining on a relatively small surface area of the ceramic disc. At 72 hours, the filter cake appeared to be completely removed from the ceramic disc, although it may be possible that residual amounts still remained.

For the formulation of Example 2, the filter cake appeared to be completely removed from the ceramic disc after soaking for 24 hours, although it may be possible that residual amounts still remained. The Darcy ceramic disc was cracked, which may be due to a poor quality disc, or possibly due to relatively high differential pressures.

For the formulation of Example 3, after soaking for 24 hours, the majority of the surface of the 2 Darcy ceramic disc was still covered by filter cake, although a substantial portion of the filter cake had been removed. Similarly at 48 hours, the 2 Darcy ceramic disc was still partially covered by filter cake. At 72 hours, the filter cake appeared to be completely removed from the ceramic disc, although it may be possible that residual amounts still remained.

For the formulation of Example 4, after soaking the filter cake for 48 hours at different temperatures, the remaining oxide on the filtercake was inspected. Results are shown in the table below. The results indicate that clean-up results improve as treating temperatures increase. Cleanup is shown in the table as a percent of filter cake removed from the ceramic disc.

| DIF | Treating | | | | |
|---|---|---|---|---|---|
| Density | fluid | Leak-off | Treating | Soaking | Clean-up |
| (PPG) | volume | time | temp | time | % |
| 11.0 | 100 ml | 30 mins | 150° F. | 48 hrs | 28% |
| 11.0 | 100 ml | 30 mins | 180° F. | 48 hrs | 41% |
| 11.0 | 100 ml | 30 mins | 200° F. | 48 hrs | 92% |

Thus, all of the above Example formulations effectively removed the filter cake. Both the Example 1 and Example 3 formulations also provided acceptable delay for removing filter cake.

Although various embodiments have been shown and described, the present disclosure is not so limited and will be understood to include all such modifications and variations as would be apparent to one skilled in the art.

What is claimed is:

1. A well servicing fluid emulsion formulated with components comprising:
an ester of an organic acid for which the pKₐ of the organic acid is less than 0;
an aqueous based fluid; and
an emulsifier,
wherein the ester of organic acid is dispersed in the aqueous based fluid to form the well servicing fluid emulsion.

2. The fluid of claim 1, wherein the ester of organic acid is an ester of a strong organic acid.

3. The fluid of claim 2, wherein the ester of strong organic acid is chosen from esters of sulfonic acids.

4. The fluid of claim 2, wherein the ester of strong organic acid is chosen from acids having the general formula R¹—S(═O)₂OR², where R¹ and R² are independently chosen from C₁ to C₁₂ aryl groups and C₁ to C₁₂ aliphatic groups.

5. The fluid of claim 2, wherein the ester of strong organic acid is an ester of toluene sulfonic acid.

6. The fluid of claim 1, wherein aqueous based solvent is chosen from fresh water, brine, seawater and produced water.

7. The fluid of claim 1, wherein the aqueous based solvent is a brine comprising a concentration of salt of 0.5% by weight or more, based on the total weight of the brine.

8. The fluid of claim 1, further comprising at least one enzyme chosen from xanthanase, hemicellulase, Cellulase enzyme, bacterial amylase, and other glycosyl hydrolases.

9. The fluid of claim 8, further comprising at least one pH buffer chosen from NaOH, KOH, potassium bicarbonate, sodium bicarbonate, potassium carbonate, and sodium carbonate.

10. The fluid of claim 8, wherein the emulsifier is a nonionic emulsifier.

11. The fluid of claim 1, wherein the fluid is formulated with at least one additional compound chosen from oxidizers, chelating agents, surfactants, clay stabilization additives, scale dissolvers, high temperature stabilizers, corrosion inhibitors, corrosion intensifiers, mutual solvents and alcohols.

12. The fluid of claim 1, wherein the ester is dispersed in the aqueous based fluid to form an oil-in-water emulsion.

13. The fluid of claim 1, wherein the ester is dispersed in the aqueous based fluid to form a single phase microemulsion.

14. A method of removing filter cake from a well, the method comprising:
providing a well servicing fluid formulated with ingredients comprising an ester of an organic acid for which the pKₐ of the organic acid is less than 0, an aqueous based solvent, and an emulsifier; and
introducing the well servicing fluid into the well so as to contact a well formation having filter cake deposited thereon, the well servicing fluid removing at least a portion of the filter cake from the well formation.

15. The method of claim 14, wherein the ester of organic acid is an ester of strong organic acid.

16. The method of claim 15, wherein the ester of strong organic acid is chosen from esters of organic suifortic acids.

17. The method of claim 15, wherein the ester of strong organic acid is chosen form acids havina the general formula R¹—S(═O)₂OR², where R¹ and R² are independantly chosen from C₁ to C₁₂ aryl groups and C₁ to C₁₂ aliphatic groups.

18. The method of claim 15, wherein the ester of strong organic acid is an ester of toluene sulfonic acid.

19. The method of claim 14, wherein the ester is dispersed in the aqueous based fluic to form an oil-in-water emulsion.

20. The method of claim 14, wherein the ester is dispersed in the aqueous based fluid to form a single phase microemulsion.

21. The method of claim 14, wherein the ester is an ester of organic sulfonic acid that hydrolyzes to form acid after being introduced into the well.

22. The method of claim 14, wherein aqueous based solvent is chosen from fresh water, brine, seawater and produced water.

23. The method of claim 14, wherein the aqueous based solvent is a brine comprising a concentration of salt of 0.5% by weight or more, based on the total weight of the brine.

24. The method of claim 14, further comprising at least one enzyme chosen from xanthanase, hemicellulase, Cellulose enzyme, bacterial amylase, and other glycosyl hydrolases.

25. The method of claim 24, further comprising at least one pH buffer chosen from NaOH, KOH, potassium bicarbonate, sodium bicarbonate, potassium carbonate, and sodium carbonate.

26. The method of claim 14, wherein the emulsifier is a non-ionic emulsifier.

27. The method of claim 14, further comprising depositing a filter cake prior to introducing the well servicing fluid, the filter cake being deposited by contacting the formation with drilling fluid.

28. The method of claim 14, wherein the filter cake comprises at least one component chosen from carbonates and polymers.

29. The method of claim 14, wherein the well is chosen from a horizontal well, an extended reach well and a multi-lateral well.
